(19) United States
(12) Patent Application Publication
(10) Pub. No.: US 2014/0358552 A1
(43) Pub. Date: Dec. 4, 2014

(54) LOW-POWER VOICE GATE FOR DEVICE WAKE-UP

(71) Applicant: Cirrus Logic, Inc., Austin, TX (US)

(72) Inventor: Jefferson L. Xu, Austin, TX (US)

(21) Appl. No.: 13/907,679

(22) Filed: May 31, 2013

(51) Int. Cl. G06F 1/32; G06F 3/16

(52) U.S. Cl. CPC G06F 1/3234; G06F 3/16
USPC 704/275

(57) ABSTRACT

A staged processing system may be configured to reduce power consumption during voice detection in an audio signal. A first stage may include detecting a minimal threshold of sound in an audio signal. A second stage may then be activated to apply a Teager operator to determine a signal-to-noise ratio of speech energy in an audio signal. When a minimum SNR is detected, a third stage may be activated to detect periodicity in the audio signal and identify a voice signal in the audio signal. When a voice signal is detected, a fourth stage may be activated to process the voice command.

### FIELD OF THE DISCLOSURE

The instant disclosure relates to mobile devices. More specifically, this disclosure relates to power reduction for mobile devices.

### BACKGROUND

People generally communicate the most comfortably through spoken words. However, human interaction with electronic devices has conventionally been through tactile methods, such as interacting with a physical keyboard and mouse and recently through touch screens. In the case of tactile interaction, input from a user is easily detectible through activation of a key on the keyboard or through a change in capacitance of a touch screen device. Tactile input may involve no processing or limited processing to detect the beginning of interaction with a user. For example, a physical key stroke may be detected through a pressure sensor detecting when a key is pressed. In another example, a swipe on a touch screen may be detected by determining when a capacitance value of the touch screen crosses a threshold. In tactile input, there are few false positives for detecting the initiation of user interaction. That is, rarely does an electronic device detect a swipe motion on a touch screen or detect a key press on a keyboard when a user has not intended to start interacting with the electronic device.

Audio input to electronic devices may be more comfortable and easier for users. For example, interacting with an electronic device may require two hands to type on a keyboard or two thumbs to type on a mobile device. Audio input could instead be provided to the electronic device with only one hand holding the device, or even with no hands. For example, a user may have a mobile device located in a pocket and configured in hands-free mode for receiving audio input through a wireless headset. However, noise in the vicinity of an electronic device is always providing input to a microphone of the electronic device. That is, there is always background noise and only rarely does the background noise contain audio input intended for the electronic device. Furthermore, the audio input may be difficult to differentiate from background noise, particularly when using a single microphone input. Thus, an electronic device must continuously process audio signals received by a microphone in the electronic device to determine whether an audio input is present. This processing consumes resources of the electronic device, which may lead to slower response times for the processor to complete other tasks and may negatively affect the battery life of the electronic device.

One conventional solution is to not process audio signals by the electronic device until a user signals to the electronic device that an audio input is beginning. For example, a user may select a “voice search” icon on an electronic device causing the electronic device to begin recording audio signals from a microphone and processing the audio signals to identify an audio input. However, this conventional solution is less comfortable for the user and reduces the likelihood of the user interacting with the electronic device through audio input.

Shortcomings mentioned here are only representative and are included simply to highlight that a need exists for improved electronic devices, particularly in consumer-level devices. Embodiments described here address certain shortcomings but not necessarily each and every one described here or known in the art.

### SUMMARY

Voice activation of an electronic device may improve the intelligence of the electronic device and provide a more comfortable input method for a user. Voice activation may be useful, for example, on a smart phone when the user is providing audio input to the smart phone when the user does not have any free hands, such as when driving a car. The audio input may be detected by a voice gate in an electronic device, which may generate a wake-up signal to activate other components in the electronic device. For example, the voice gate may be located in a low-power component of the electronic device to reduce power consumption when no audio input is detected. When audio input is detected, the voice gate may send a wake-up signal to another component of the electronic device, such as an application processor, to perform operations based on the audio input. Thus, the voice gate may reduce power consumption of the electronic device while the electronic device is waiting for audio input from a user.

The voice detection may be staged to further reduce power consumption. For example, a first stage may detect when audio signals reach a threshold level. When the audio signals have enough sound, a second stage may be activated to detect increasing instantaneous signal energy. When increasing signal energy is detected, indicating a probability of a voice signal, a third stage may be activated to search for periodicity in the audio signal, matching periodicity generated by human vocal cords. When periodicity is detected, a fourth stage may be activated to processing the audio signal, determine voice commands in the audio signal, and carry out the instructions in the voice command.

In certain embodiments, a signal-to-noise (SNR) ratio of an audio signal may be calculated based, at least in part, on a result of applying a Teager operator to the audio signal. The application of the Teager operator to an audio signal to calculate a SNR may be implemented as part of a system with speech energy detection and voice signal detection to provide a more robust and accurate method for identifying a voice signals in different and changing environments.

In one embodiment, a method may include receiving, at a processor, an audio signal. The method also includes applying, at the processor, a Teager operator to the audio signal to calculate an instantaneous change of energy in the audio signal. The method may further include calculating, at the processor, a signal-to-noise ratio (SNR) of the audio signal based, at least in part, on the calculated instantaneous change of energy. The method may also include, when the SNR is above a signal threshold, setting a first detection flag.

The method may also include when the first detection flag is set calculating a peakness based on a cepstrum of the audio signal, and when the peakness is above a threshold, setting a second detection flag; when the second detection flag is set, waking a second processor for recognizing speech commands in the audio signal; calculating the instantaneous change of energy for a search window within the audio signal, and computing a noise level based on a minimum energy value within the search window; adjusting the signal threshold by estimating environmental fluctuations; classifying the environmental fluctuations based on at least one of a mean energy value of the audio signal and a standard deviation of the audio signal; and/or setting noise tracking coefficients for classifying the environmental fluctuation, and adjusting the noise tracking coefficients.

According to another embodiment, an apparatus may include an audio signal input, and a voice gate coupled to the audio signal input. The voice gate includes a speech energy detection module configured to apply a Teager operator to an audio signal to calculate an instantaneous change of energy of the audio signal input and configured to calculate a signal-to-noise ratio (SNR) of the audio signal based, at least in part, on the calculated instantaneous change of energy. The voice gate may also include a detection flag output, in which the detection flag output is set when the SNR is above a signal threshold.

The apparatus may also include a buffer coupled to the audio signal input, in which the buffer is configured to buffer incoming audio from the audio signal input; a decimation filter coupled to the voice gate and to the audio signal input, in which the decimation filter configured to reduce a sampling rate of audio samples from the audio signal input; an audio sample processing module coupled to the voice gate, in which the audio sample processing module is configured to power down the voice gate when the signal level is below a wake-up threshold; an analog-to-digital converter coupled to the audio signal input and to the voice gate, in which the analog-to-digital converter is configured to convert an analog signal from the audio signal input to digital when the signal level is above the wake-up threshold; a voice signal detection module coupled to the detection flag output, in which the voice signal detection module is configured to calculate a peakness based on a cepstrum of the audio signal, and when the peakness is above a threshold, generate a wake-up signal; and/or an application processor coupled to the voice gate, in which the application processor is configured to further process the audio signal to determine a voice command in the audio signal, when the wake-up signal is generated. In certain embodiments, the speech energy detector is further configured to adjust the signal threshold based, at least in part, on an environmental fluctuation.

According to yet another embodiment, a computer program product may include a non-transitory computer readable medium comprising code to perform the step of receiving, at a processor, an audio signal. The medium may also include code to perform the step of applying, at the processor, a Teager operator to the audio signal to calculate an instantaneous change of energy in the audio signal. The medium may further include code to perform the step of calculating, at the processor, a signal-to-noise ratio (SNR) of the audio signal based, at least in part, on the calculated instantaneous change of energy. The medium may also include code to perform the step of when the SNR is above a signal threshold, setting a first detection flag.

The computer program product may also include code to perform the steps of when the first detection flag is set, calculating a peakness based on a cepstrum of the audio signal, and when the peakness is above a threshold, setting a second detection flag; when the second detection flag is set, waking a second processor for recognizing speech commands in the audio signal; adjusting the signal threshold by estimating environmental fluctuations; calculating the instantaneous change of energy for a search window within the audio signal; and/or computing a noise level based on a minimum energy value within the search window.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the specific embodiments disclosed may be readily utilized as a basis for modifying or designing other structures for carrying out the same or similar purposes. It should also be realized that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a voice gate implementation according to one embodiment of the disclosure.

FIG. 2 is a flow chart illustrating a method of detecting increasing instantaneous energy in an audio signal according to one embodiment of the disclosure.

FIG. 3 is graphs illustrating the results of application of a Teager operator to an audio signal containing pink noise and voice sounds according to one embodiment.

FIG. 4 is graphs illustrating the results of application of a Teager operator to an audio signal containing car noise and voice sounds according to one embodiment.

FIG. 5 is graphs illustrating the results of applying a Teager operator to an audio signal containing people talking with machine operating noise according to one embodiment.

FIG. 6 is a block diagram illustrating detecting of voices in an audio signal with consideration of environmental fluctuations according to one embodiment of the disclosure.

FIG. 7 is a flow chart illustrating an algorithm for detecting voices in an audio signal while adaptively tracking noise level and fluctuation according to one embodiment of the disclosure.

FIG. 8 is a graph illustrating noise tracking of various background noises according to one embodiment of the disclosure.

FIG. 9 is graphs illustrating calculation of a cepstrum from a voiced signal with pink noise according to one embodiment of the disclosure.

FIG. 10 is graphs illustrating calculation of a cepstrum from a voiced signal with pink noise according to another embodiment of the disclosure.

### DETAILED DESCRIPTION

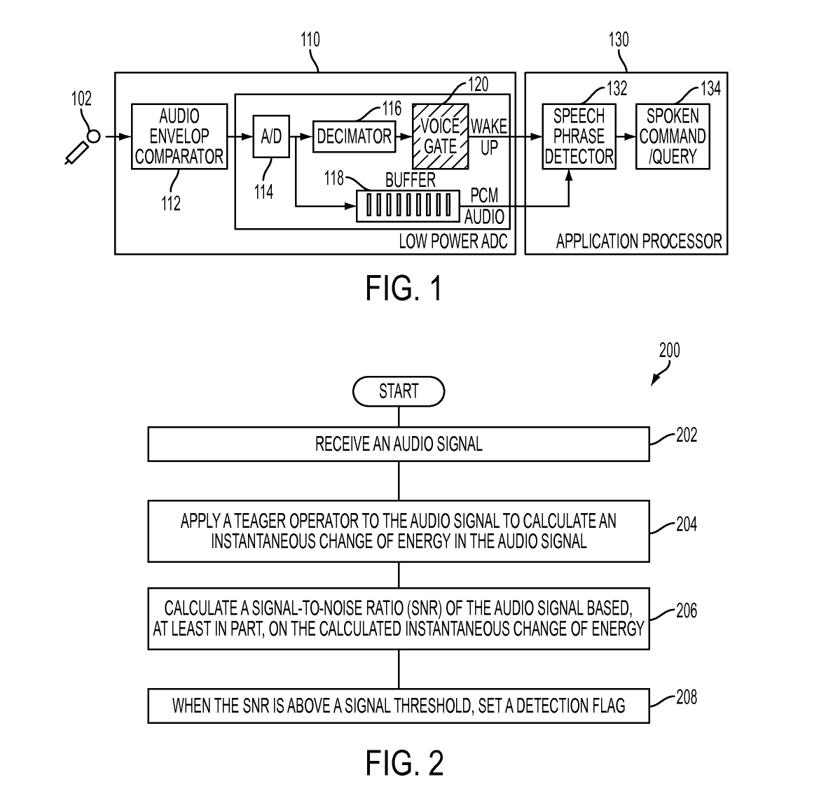

FIG. 1 is a block diagram illustrating a voice gate implementation according to one embodiment of the disclosure. A microphone 102 may be coupled to a first chip 110, such as a low-power analog-digital converter (ADC). The first chip 110 may include a voice gate 120. The voice gate 120 may be implemented as hardware inside an audio coder-decoder (CODEC), as hardware inside a digital signal processor (DSP), as hardware inside an application-specific integrated circuit (ASIC), or as an algorithm executed by a general-purpose central processing unit (CPU). According to one embodiment, the voice gate 120 may operate at a low clock frequency to reduce power consumption. The first chip 110 may also include other components, such as an analog-digital converter 114, a decimator 116, and a buffer 118. The first chip 110 may be coupled to a second chip 130, such as an application processor. The second chip 130 may include a speech phrase detector 132 and a spoken command processor 134.

The first chip 110 may receive an audio signal from the microphone 102 and process the audio signal to detect voice signals. When a voice signal is detected in the audio signal, the first chip 110 may set a detection flag and transmit a wake-up signal to the second chip 130. The voice gate 120 may process data from an audio signal received at the microphone 102 and output the wake-up signal based on the contents of the audio signal.

The audio signal from the microphone 102 may be stored in the buffer 118 and provided to the second chip 120. For example, when the first chip 110 outputs a wake-up signal to the second chip 130, and the second chip 130 may access a previous portion of the audio signal located in the buffer 118. The buffer 118 may reduce or prevent loss of an audio input from a user while the first chip 110 detects the audio input and while the second chip 130 initializes in response to the wake-up signal. The buffer 118 may store, for example, two seconds of audio signal from the microphone 102. The buffer 118 may be, for example, a circular buffer or a first-in-first-out (FIFO) buffer.

Although shown as two separate chips, the first chip 110 and the second chip 130 may be separate components of a single chip package. For example, the first chip 110 and the second chip 130 may be placed in a package-on-package integrated circuit (PoP IC). In another example, the first chip 110 and the second chip 130 may be manufactured on a common substrate with a gating scheme to allow the second chip 130 to operate in a sleep state while the first chip 110 operates in an active state.

The voice gate 120 may be coupled to the microphone 102 through an audio envelope comparator 112. The audio envelope comparator 112 may detect when an audio signal from the microphone 102 contains an envelope that is larger than a pre-defined threshold. A signal from the audio envelope comparator 112 may be analyzed to place analog-to-digital converter 114, the voice gate 120, and/or other components into a reduced-power mode during quiet periods. For example, during night-time, the audio envelope comparator 112 may generate a signal that instructs analog-to-digital converter 114, the voice gate 120, and/or other components to enter a sleep mode. Thus, the audio envelope comparator 112 may further decrease power consumption within an electronic device.

When the audio envelope comparator 112 detects an audio signal from the microphone 102 above a threshold level, the audio signal may be processed by an analog-to-digital converter (ADC) 114. The digital output of the ADC 114 may be provided to a decimator 116 and the buffer 118. The decimator block 116 may downsample the audio signal received from the microphone 102. For example, the decimator block 116 may reduce the audio signal to a signal with a 4 KHz bandwidth for further processing by the voice gate 120. Downsampling the audio signal received from the microphone 102 may allow the voice gate 120 to be simplified, such that the voice gate 120 consumes reduced power and occupies reduced die space in a packaged integrated circuit. The buffer 118 may store the undecimated audio signal for later processing by the second chip 130.

The voice gate 120 may execute, in hardware and/or software, an algorithm for detecting increasing signal energy, such as the algorithm illustrated in FIG. 2. FIG. 2 is a flow chart illustrating a method of detecting increasing signal energy in an audio signal according to one embodiment of the disclosure. A method 200 begins at block 202 with receiving an audio signal, such as from a microphone coupled to or integrated in an electronic device.

At block 204, a Teager operator is applied to the audio signal to calculate an instantaneous change of energy in the audio signal. The calculation of instantaneous energy using a Teager operator in discrete time may be calculated by

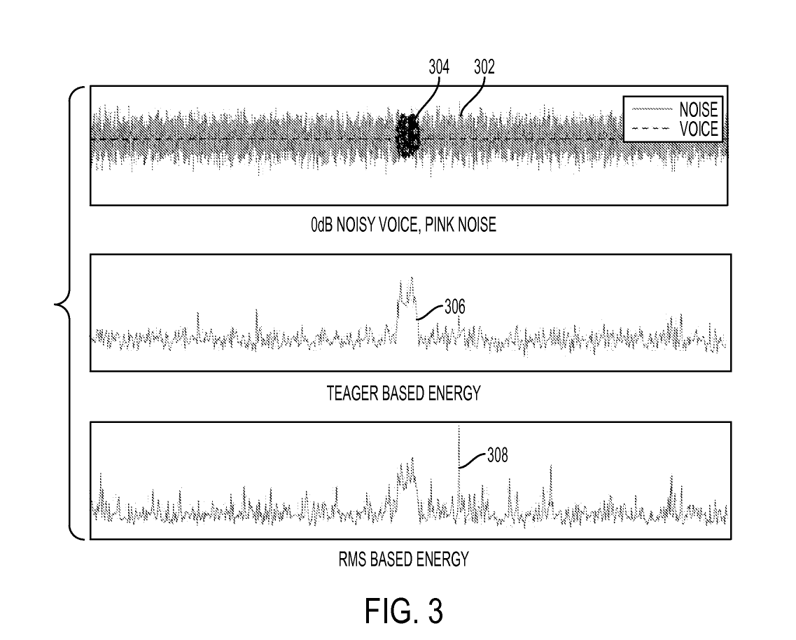

p(n)=x(n)²−x(n−1)x(n+1),

where p(n) is a discrete energy level of a signal x(n) at sample number n. The Teager operator provides an ability to track a change in a signal and measure signals of different types. For example, a Teager operator may be applied to an audio signal to detect oscillation sounds, such as voiced sounds generated by vocal cord vibration. A detected instantaneous change in frequency and/or energy may provide an indication that an audio input to the electronic device is beginning. Examples of Teager operator provided to different signals are shown in FIGS. 3, 4, and 5.

FIG. 3 is graphs illustrating the results of application of a Teager operator to an audio signal containing pink noise and voice sounds according to one embodiment. Lines 302 and 304 illustrate deconstructed audio signals for pink noise and voice, respectively. When an audio signal containing the pink noise and voice is analyzed with a Teager operator, a line 306 is generated. A pulse in the output of the calculation based on the Teager operator is correlated with the position of a voice within the audio signal. For comparison, a calculation based on a root mean square (RMS) operator is shown as line 308.

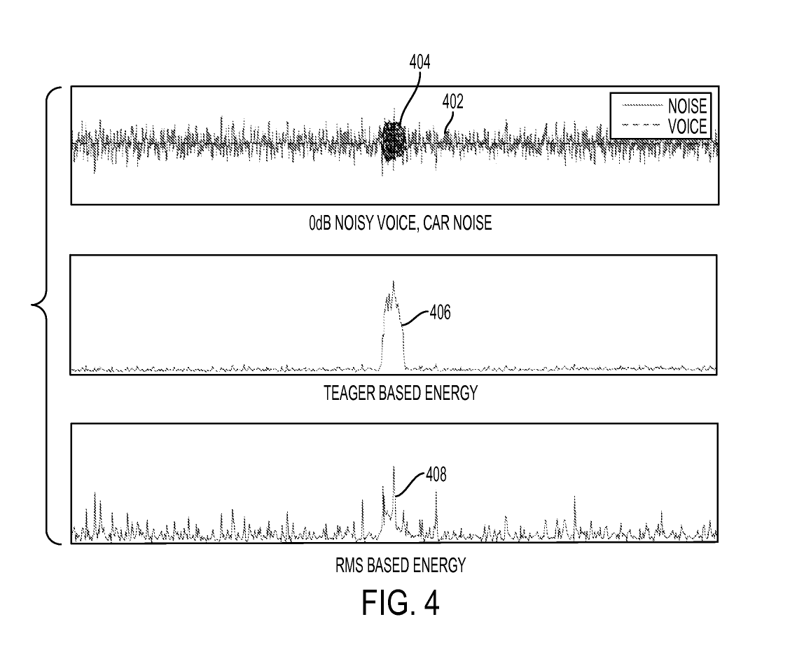

FIG. 4 is graphs illustrating the results of application of a Teager operator to an audio signal containing car noise and voice sounds according to one embodiment. Lines 402 and 404 illustrate deconstructed audio signals for car noise and voice, respectively. When an audio signal containing the car noise and voice is analyzed with a Teager operator, a line 406 is generated. A pulse with certain width in the output of the calculation based on the Teager operator is correlated with the position of a voice within the audio signal. For comparison, a calculation based on a root mean square (RMS) operator is shown as line 408.

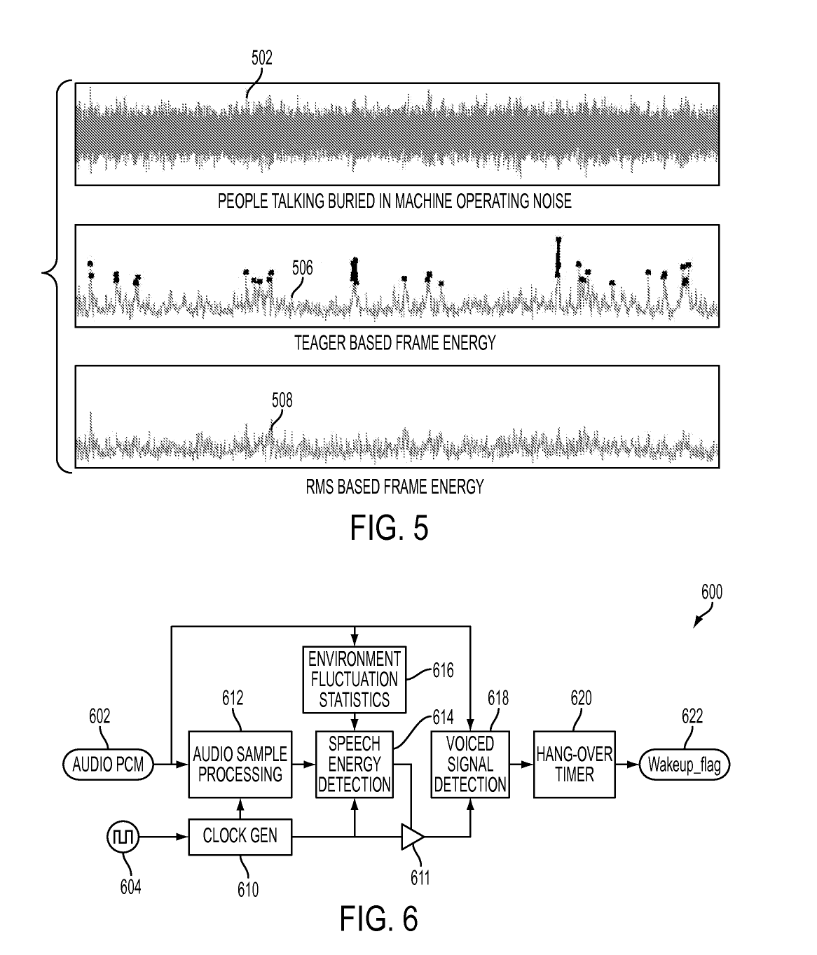

FIG. 5 is graphs illustrating the results of applying a Teager operator to an audio signal containing people talking with machine operating noise according to one embodiment. Line 502 illustrates an audio signal containing the voice and machine operating noise. When an audio signal containing the machine operating noise and voice is analyzed with a Teager operator, a line 506 is generated. Spikes in the output of the calculation based on the Teager operator are correlated with the positions of voices, such as low amplitude voices, within the audio signal. For comparison, a calculation based on a root mean square (RMS) operator is shown as line 508.

Referring back to the method 200 illustrated in the flow chart of FIG. 2, at block 206, a signal-to-noise (SNR) ratio is calculated for the audio signal based, at least in part, on the calculated instantaneous change of energy calculated at block 204. The SNR ratio calculated for the audio signal may also be based on environmental conditions and other factors, in addition to the calculated instantaneous change of energy.

At block 208, when the SNR ratio is above a threshold level, a detect flag is set. The detection flag may be, for example, a register in a chip that causes an output of a wake-up signal, or an enable signal to activate the clock fed to other processing blocks. When the SNR ratio is above a threshold, the method 200 determines that a voice may be present in the audio signal. The detect flag may cause the activation of a processor to further analyze the audio signal and detect the voice command.

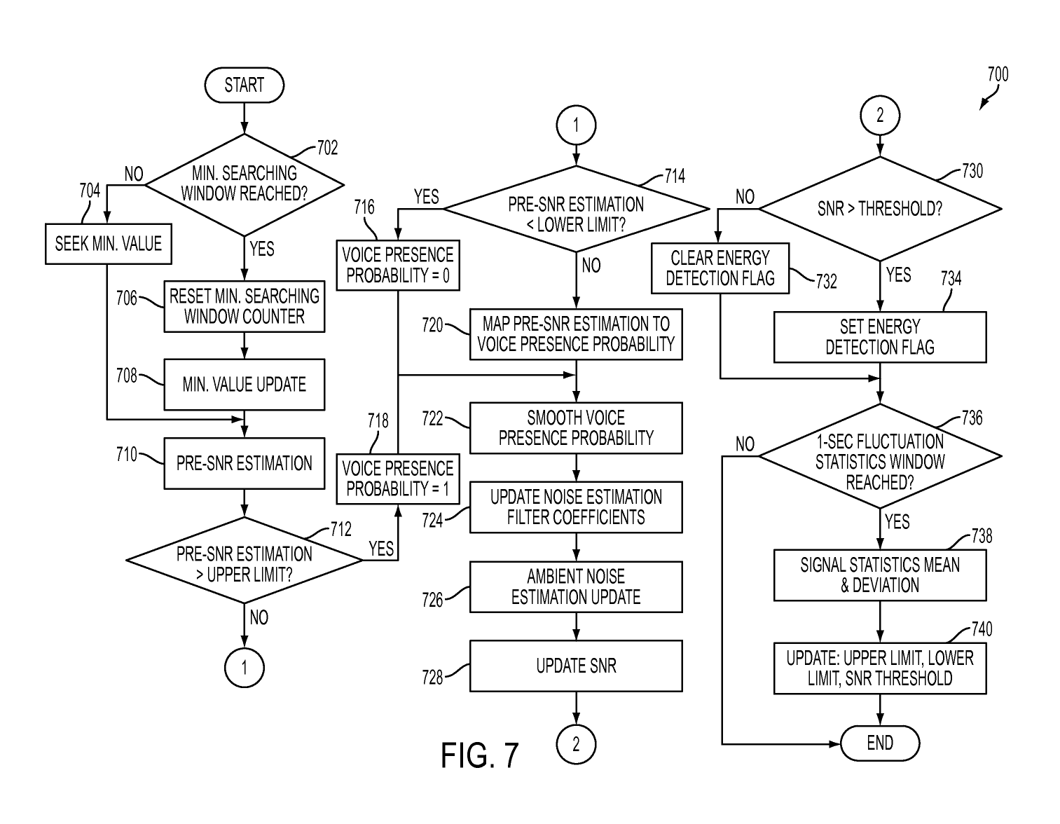

FIG. 6 is a block diagram illustrating detecting of voices in an audio signal with consideration of environmental fluctuations according to one embodiment of the disclosure. An audio signal 602, such as a pulse code modulated (PCM) signal, may be input to an audio sample processing block 612 of the system 600. The audio sample processing block 612 may process the audio sample rate based signal 602 and provide output data expressing the frame energy to a speech energy detection block 614. The audio sample processing block 612 may process the sample based on audio data and the Teager operator, then sum them together to obtain a frame energy. According to one embodiment, a frame may have a size of between approximately 128 and approximately 160 samples from an audio sample.

The speech energy detection block 614 may determine when the audio signal 602 includes a change in instantaneous energy corresponding to a possible voice signal. The speech energy detection block 614 may receive an input signal from an environmental fluctuation statistics block 616. The environmental fluctuation statistics block 616 may receive the audio signal 602 and determine an environmental noise level. For example, the environmental fluctuation statistics block 616 may determine whether the audio signal 602 is recorded from an airplane, a car, an office, an outdoor park, etc. The speech energy detection block 614 may use environmental statistics to determine when the instantaneous change in energy indicates a likely voice signal.

The output of the speech energy detection block 614 may trigger a voiced signal detection block 618 to perform further processing on the audio signal 602. The voiced signal detection block 618 may calculate a signal-to-noise ratio (SNR) for the audio signal 602 and determine whether a voice is present in the audio signal 602. The voiced signal detection block 618 may output a detection flag. The detection flag may be processed to produce a wake-up signal 622 transmitted to another chip. In one embodiment, the output of the voiced signal detection block 618 may be provided to a hang-over timer 620 that may deactivate the wake-up signal after a certain amount of time, such as 500 milliseconds.

A global clock signal 604 of a system 600 may be input to a clock generator 610, which generates a local clock for synchronizing operations within the system 600. The clock generator 610 may supply a local clock to processing blocks, such as the audio sample processing block 612 and the speech energy detection block 614. Alternatively, synchronization of processing within the system 600 may be timed to the global clock signal 604 without a local clock signal.

Furthermore, the clock generator 610 may turn on or off clock signals to various blocks of the system 600 to reduce power consumption by the system 600. For example, the clock generator 610 may stop providing a clock to the voiced signal detection block 618 when the speech energy detection block 614 does not detect speech energy. In one embodiment, the output of clock generator 610 may be passed through a tri-state buffer 611 that receives the output of the speech energy detection block 614 as an enable input. The speech energy detection block 614 may execute an algorithm for increasing energy detection when speech energy may be present in an audio signal.

FIG. 7 is a flow chart illustrating an algorithm for speech energy detection in an audio signal while adaptively tracking noise level and fluctuation according to one embodiment of the disclosure. A method 700 may be implemented, for example, in the voice gate 120 of FIG. 1 or the speech energy detection block 614 of FIG. 6.

The method 700 begins at block 702 with determining whether a minimum searching window is reached. For example, a half-second minimum value for a searching window may be established. If the minimum window time has not passed, the method 700 continues to block 704 to seek a minimum value. If the minimum window time has passed at block 702, then the method 700 continues to block 706 to reset the window counter and update a minimum value at block 708. The minimum amount of frame energy of block 708 may be used to form a preliminary signal-to-noise (SNR) ratio estimate at block 710. If the preliminary SNR estimate of block 710 is larger than an upper limit determined, in part, by environmental fluctuation estimate, the probability of voice presence is set to 1 at block 718. If the preliminary SNR estimate of block 710 is smaller than the upper limit, then the method 700 proceeds to block 714. At block 714, it is determined whether the preliminary SNR estimate of block 710 is lower than a lower limit. If so, then the voice presence probability is set to zero at block 716. If not, then the preliminary SNR estimate is mapped to a voice presence probability at block 720. The voice presence probability may be mapped to a value between 0 and 1, such as by a linear mapping or through a look-up table. After the voice presence probability is set at block 718, block 716, or block 720, the method proceeds to block 722.

At block 722, the voice presence probability may be smoothed, such as through a moving average method. The smoothed voice presence probability of block 722 may be used to determine a coefficient of a filter for noise floor tracking at block 724. The filter coefficient update calculates Cₙₒᵢₛₑ=C_{default}+(1−C_{default})·Probability, where C_{default} is the fault noise filter coefficient, Cₙₒᵢₛₑ the updated filter coefficient. When no voice signal is present, the Probability may be estimated as 0 at block 716, the noise floor may be obtained by low-pass filtering the frame energy with the default coefficient value, C_{default}. If the Probability is estimated as 1 at block 718, the filtering coefficient is set to 1, which determines that there is no further noise floor updating. At block 726, an ambient noise estimate may be updated with the smoothing filter based on the revised coefficient of block 724. According to one embodiment, the default filter coefficient is set at approximately 0.89.

At block 728, an updated SNR is calculated for the audio signal. If the SNR is greater than a threshold value at block 730, then an energy detection flag is set at block 734. If not, then the energy detection flag is cleared at block 732. An SNR above the threshold value may indicate that a ratio of energy of a current frame to the noise floor calculated from a previous frame signals a possibility of a voice in the audio signal. The detection flag set and cleared at respective blocks 734 and 732 may be used to generate a wake-up signal passed to another component of an integrated circuit or another chip to further process the audio signal.

At block 736, it is determined whether an environmental fluctuations statistics window is reached. The window may be, for example, one second in duration. If not, the method 700 ends. If so, the method 700 proceeds to block 738 to calculate signal statistics, such as mean and deviation, and then proceeds to block 740 to update the upper limit, the lower limit, and the SNR threshold of blocks 712, 714, and 730, respectively. Recalculating the upper limit, the lower limit, and the SNR threshold allow the algorithm of method 700 to adapt to changing environments. The method 700 may be repeated by the voice gate 120 of FIG. 1.

The method 700 provides a method for detecting a noise-corrupted voice signal in a variety of, and continuously changing, environments. For example, the algorithm may adjust to stationary and non-stationary sound environments, including babble inside restaurants and background music and noise, by statistically tracking energy level and energy fluctuation of background noise during non-speech periods. In one embodiment, the background noise may be categorized into one of three categories based, in part, on the energy mean values and deviations of the audio signal. The three categories may represent a stationary scenario, a pseudo-stationary scenario, and a non-stationary scenario. Stationary scenarios may include pink noise, air-conditioning fan noise, and jet engine noise, etc. Pseudo-stationary scenarios may include car noises. Non-stationary scenarios may include defused babble noise captured in an office or restaurant, background music, and street noise, etc.

The upper limit, lower limit, and SNR threshold values of the method 700 may be adapted based on which of the three categories of noise is detected. For example, when operating in the category corresponding to a non-stationary scenario, the three parameters may be raised to reduce the likelihood of falsely detecting a voice signal presence in the audio signal.

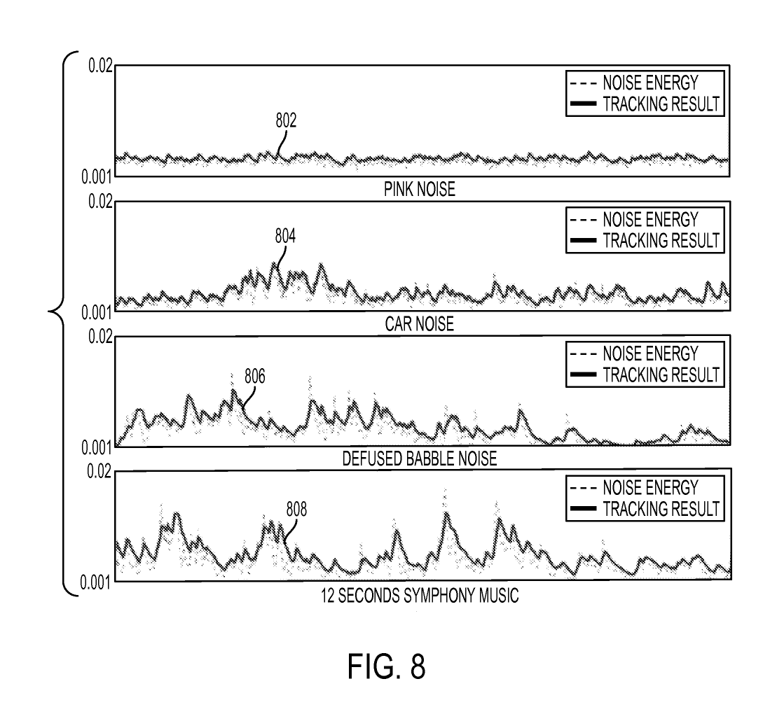

The adaptation of the threshold values of the method 700 allows for noise tracking of numerous background environments. FIG. 8 is a graph illustrating noise tracking of various background noises without any false positive according to one embodiment of the disclosure. A line 802 illustrates noise tracking of pink noise over time. A line 804 illustrates noise tracking of car noise over time. A line 806 illustrates noise tracking of defused babble noise over time. A line 808 illustrates tracking of symphony music over time.

Referring back to FIG. 6, the voiced signal detection block 618 may be activated when the speech energy detection block outputs an energy detection flag. The voiced signal detection block 618 may provide a more accurate determination than the speech energy detection block 614 of whether a voiced signal is present in the audio signal 602. The voiced signal detection block 618 may sample the audio signal 602 to obtain, for example, 512 samples of the audio signal 602 at an 8 KHz sampling rate. The samples may be obtained by applying a Fast Fourier Transform (FFT) to a Hamming window of the audio signal 602. A logarithmic computation may be applied to the samples to compress the dynamic range of the spectrum. According to one embodiment, the dynamic range may be focused on a range between 50 and 400 Hertz to accommodate human speech fundamental frequency's range. Voiced signal may be detected by identifying periodicity of the spectrum of the samples. Periodicity is particularly present in voiced sounds in a language, such as vowels and certain consonants in the English language or the Chinese language. In one embodiment, a high-pass filter may be applied to remove low frequency components.

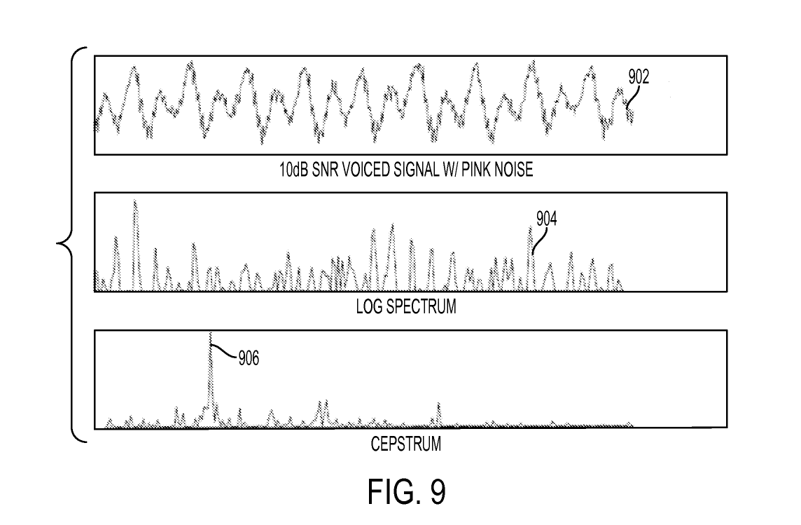

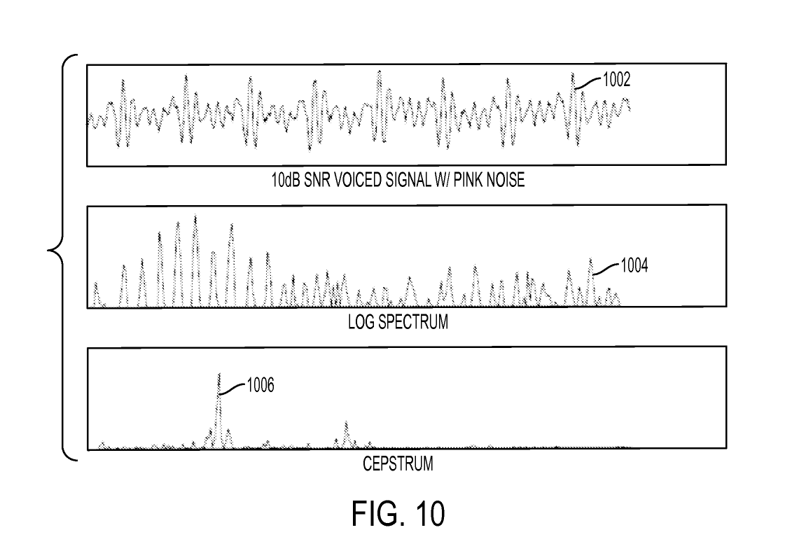

Then, a second FFT may be calculated to produce a cepstrum of the audio signal. If the audio signal 602 is produced by excitations of human vocal cords, a peak may be produced in the cepstrum of the samples from the audio signal 602. A peakness detection may be performed by comparing accumulation of cepstrum peak values and a number of bins around the peak to the average amplitude of the entire cepstrum. In one embodiment, the cepstrum peak values and two bins on either side of peak values may be compared to the average amplitude. When a peak is identified relative to the average amplitude, the location of the peak is examined to determine if the location is within the human speech period range. If not, the current sample of the audio signal is determined to be a non-voiced signal. If so, the current sample of the audio signal is determined to be a voiced signal, and a wake-up signal may be generated in response. Calculation of a cepstrum is illustrated in FIGS. 9 and 10.

FIG. 9 is graphs illustrating calculation of a cepstrum from a voiced signal with pink noise according to one embodiment of the disclosure. A line 902 illustrates a 10 decibel (dB) SNR voiced signal mixed with pink noise. A line 904 illustrates the log spectrum of the signal of line 902. A line 906 illustrates the calculated cepstrum of the signal of line 902. A peak occurs in the line 906 corresponding to a voiced signal.

FIG. 10 is graphs illustrating calculation of a cepstrum from another voiced signal with pink noise according to another embodiment of the disclosure. A line 1002 illustrates a 10 dB SNR voiced signal mixed with pink noise. A line 1004 illustrates a log spectrum of the signal of the line 1002. A line 1006 illustrates the calculated cepstrum of the signal of line 1002. A peak occurs in the line 1006 corresponding to a voiced signal.

Detection of audio input from a user with speech energy detection and voiced signal detection may have a reduced rate of false triggers. The speech energy detection process may include application of a Teager operator to compute a signal-to-noise (SNR) ratio of the audio signal. When speech energy above a threshold level is detected, voiced signal detection of the audio signal may be performed. The voiced signal detection identifies quasi-periodicity in the spectrum of the audio signal resulting from the periodicity in a voice signal.

This staged audio input detection, including a first stage of speech energy detection and a second stage of voiced signal detection may be implemented to reduce power consumption during speech detection. Furthermore, the determination of the first stage and the second stage may be used to generate a wake-up signal that wakes another algorithm, such as one executed in an application processor, to perform further analysis on the audio signal, such as determining the voice commands in the audio signal. Reducing false positives from the first stage and the second stage reduce the amount of time the application processor is active, which reduces battery consumption in the electronic device.

Execution of the staged detection algorithm may reduce power consumption. For example, the first stage may detect increasing energy under various noise environments while consuming little power. The second stage may operate in a duty-cycle mode, in which it is turned on only when the audio signal passes the first stage detection. In a mobile device powered by batteries, this algorithm may allow continuous operation of voice detection while the mobile device is powered on.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain of its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving, at a processor, an audio signal;
applying, at the processor, a Teager operator to the audio signal to calculate an instantaneous change of energy in the audio signal;
calculating, at the processor, a signal-to-noise ratio (SNR) of the audio signal based, at least in part, on the calculated instantaneous change of energy; and
when the SNR is above a signal threshold, setting a first detection flag.

2. The method of claim 1, further comprising:
when the first detection flag is set:
calculating a peakness based on a cepstrum of the audio signal; and
when the peakness is above a threshold, setting a second detection flag.

3. The method of claim 2, further comprising when the second detection flag is set, waking a second processor for recognizing speech commands in the audio signal.

4. The method of claim 1, in which the step of calculating comprises calculating the instantaneous change of energy for a search window within the audio signal, and the step of calculating the SNR of the audio signal comprises computing a noise level based on a minimum energy value within the search window.

5. The method of claim 1, further comprising adjusting the signal threshold by estimating environmental fluctuations.

6. The method of claim 5, in which the step of calculating the threshold comprises classifying the environmental fluctuations based on at least one of a mean energy value of the audio signal and a standard deviation of the audio signal.

7. The method of claim 6, further comprising:
setting noise tracking coefficients for classifying the environmental fluctuation; and
adjusting the noise tracking coefficients.

8. The method of claim 1, in which the processor is an analog-to-digital converter (ADC).

9. An apparatus, comprising:
an audio signal input; and
a voice gate coupled to the audio signal input, the voice gate comprising:
a speech energy detection module configured to apply a Teager operator to an audio signal to calculate an instantaneous change of energy of the audio signal input and for calculating a signal-to-noise ratio (SNR) of the audio signal based, at least in part, on the calculated instantaneous change of energy; and
a detection flag output, in which the detection flag output is set when the SNR is above a signal threshold.

10. The apparatus of claim 9, further comprising a buffer coupled to the audio signal input, in which the buffer is configured to buffer incoming audio from the audio signal input.

11. The apparatus of claim 9, further comprising a decimation filter coupled to the voice gate and to the audio signal input, the decimation filter configured to reduce a sampling rate of audio samples from the audio signal input.

12. The apparatus of claim 9, further comprising:
an audio sample processing module coupled to the voice gate, in which the audio sample processing module is configured to power down the voice gate when the signal level is below a wake-up threshold; and
an analog-to-digital converter coupled to the audio signal input and to the voice gate, in which the analog-to-digital converter is configured to convert an analog signal from the audio signal input to a digital signal when the signal level is above the wake-up threshold.

13. The apparatus of claim 9, in which the speech energy detector is further configured to adjust the signal threshold based, at least in part, on an environmental fluctuation.

14. The apparatus of claim 9, in which the voice gate further comprises a voiced signal detection module coupled to the detection flag output, in which the voiced signal detection module is configured to:
calculate a peakness based on a cepstrum of the audio signal; and
when the peakness is above a threshold, generate a wake-up signal.

15. The apparatus of claim 14, further comprising an application processor coupled to the voice gate, in which the application processor is configured to further process the audio signal to determine a voice command in the audio signal, when the wake-up signal is generated.

16. A computer program product, comprising:
a non-transitory computer readable medium comprising code to perform the steps comprising:
receiving, at a processor, an audio signal;
applying, at the processor, a Teager operator to the audio signal to calculate an instantaneous change of energy in the audio signal;
calculating, at the processor, a signal-to-noise ratio (SNR) of the audio signal based, at least in part, on the calculated instantaneous change of energy; and
when the SNR is above a signal threshold, setting a first detection flag.

17. The computer program product of claim 16, in which the medium further comprises code to perform the steps of:
when the first detection flag is set, calculating a peakness based on a cepstrum of the audio signal; and
when the peakness is above a threshold, setting a second detection flag.

18. The computer program product of claim 17, in which the medium further comprises code to perform the step of, when the second detection flag is set, waking a second processor for recognizing speech commands in the audio signal.

19. The computer program product of claim 16, in which the medium further comprises code to perform the step of adjusting the signal threshold by estimating environmental fluctuations.

20. The computer program product of claim 16, in which the medium further comprises code to perform the steps of:
calculating the instantaneous change of energy for a search window within the audio signal; and
computing a noise level based on a minimum energy value within the search window.
